(19) United States
(12) Patent Application Publication
(10) Pub. No.: US 2020/0150313 A1
(43) Pub. Date: May 14, 2020

(54) ANTI-REFLECTION LENS AND METHOD FOR TREATING A LENS TO REDUCE REFLECTIONS FOR PLACENTAL MAMMALS WITH DICHROMATIC VISION

(71) Applicant: QUANTUM INNOVATIONS, INC., Central Point, OR (US)

(72) Inventors: Norman L. Kester, Rogue River, OR (US); Adam E. Winkelman, Foley, MN (US); Nicholas M. Hall, Ashland, OR (US); Richard D. Unbankes, Medford, OR (US)

(73) Assignee: QUANTUM INNOVATIONS, INC., Central Point, OR (US)

(21) Appl. No.: 16/670,927

(22) Filed: Oct. 31, 2019

Related U.S. Application Data
(60) Provisional application No. 62/760,242, filed on Nov. 13, 2018.

(51) Int. Cl. G02B 1/113; G02B 5/00; G02B 1/18

(52) U.S. Cl. CPC G02B 1/113; F41G 1/38; G02B 1/18; G02B 5/003

(57) ABSTRACT

An anti-reflection lens and method for treating a lens to reduce reflections for placental mammals with dichromatic vision. The anti-reflection lens is treated to with a coating on the surface. The coating is configured to enable the lens surface to be less perceptible to a placental mammal with dichromacy vision by reducing reflections therefrom. The lens treatment includes applying an anti-reflective coating in multiple coats. The coats comprise an adhesion composition, a low index composition (SiO₂), a high index composition (ZrO₂), and a superhydrophobic composition that are applied in subsequent layers of varying nanometer thicknesses. The treated lens exhibits minimal reflection properties in the visible range of the electromagnetic spectrum and almost no reflection in the UV-A range. This creates a lens surface that is difficult for mammals with dichromacy to see a reflection therefrom.

### CROSS-REFERENCE TO RELATED APPLICATIONS

This application claims the benefits of U.S. provisional application No. 62/760,242, filed Nov. 13, 2018 and entitled OPTICAL LENS AND METHOD FOR TREATING A LENS TO REDUCE LIGHT WAVELENGTHS TO MAKE THE OPTICAL LENS LESS PERCEPTIBLE TO MAMMALS WITH DICHROMATIC VISION, which provisional application is incorporated by reference herein in its entirety.

The present invention relates generally to an anti-reflection lens and method for treating a lens to reduce reflections for placental mammals with dichromatic vision. More so, the present invention relates to an optical lens that is treated with a coating on the surface to be perceptible to a placental mammal with dichromacy vision; whereby the lens treatment includes applying an anti-reflective coating in multiple coats comprising an adhesion composition, a low index composition (SiO₂), a high index composition (ZrO₂), and a superhydrophobic composition in subsequent layers of varying nanometer thicknesses; and whereby the treated lens exhibits minimal reflection properties in the visible range of the electromagnetic spectrum and almost no reflection in the UV-A range, so as to make it difficult for mammals with dichromacy to see a reflection therefrom.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Those skilled in the art will recognize that humans see a wide range of color as a result of three types of cones in our eyes: one that's sensitive to short-wavelength light in the blue portion of the color spectrum, one sensitive to middle-wavelength light in the green portion and a third type receptive to long-wavelength light in the red portion.

In contrast to humans' “trichromatic” vision, deer have “dichromatic” vision because they have only two types of cones, lacking the cone that's sensitive to longer wavelengths such as red and orange. This does not mean deer do not see red and orange hues, only that deer perceive the colors differently, likely the same way as a color-blind person perceives colors. Thus, the hoofed ruminant mammals see color more intensely and vibrantly as well as having the ability to see into the UV range.

It is also known that the human eye does not perceive the UV wavelengths of light. Current optical lenses and viewing surfaces reflect varying amounts of light. When optical lenses and viewing surfaces are treated in order to create visual effects or increased light transmission or sensitivity, this is generally in a spectral range and does not account for all of the wavelengths of light that dichromacy allows.

Other proposals have involved lenses that help reduce reflections for placental mammals with dichromatic vision. The problem with these lenses is that they are not treated with a unique anti-reflective coating. Also, the lenses are not adaptable to viewing devices such as rifle sites and binoculars. Even though the above cited anti-reflection lenses meet some of the needs of the market, an anti-reflection lens and method for treating a lens to reduce reflections for placental mammals with dichromatic vision that is treated with a coating on the surface to be perceptible to a placental mammal with dichromacy vision; whereby the lens treatment includes applying an anti-reflective coating in multiple coats comprising an adhesion composition, a low index composition (SiO₂), a high index composition (ZrO₂), and a superhydrophobic composition in subsequent layers of varying nanometer thicknesses; and whereby the treated lens exhibits minimal reflection properties in the visible range of the electromagnetic spectrum and almost no reflection in the UV-A range, so as to make it difficult for mammals with dichromacy to see a reflection therefrom, is still desired.

### SUMMARY

Illustrative embodiments of the disclosure are generally directed to an anti-reflection lens and method for treating a lens to reduce reflections for placental mammals with dichromatic vision. The anti-reflection lens is treated to with a coating on the surface. The coating is configured to enable the lens surface to be less perceptible to a placental mammal with dichromacy vision by reducing reflections therefrom.

In some embodiments, the lens comprises a substrate having a first face and a second face, the faces being defined by UV absorbing properties. The first face of the substrate comprises an anti-reflective coating. In one possible embodiment, the anti-reflective coating helps minimize reflection of light in the visible range of light between 400 to 700 nanometers and the ultra violet range of light between 300 to 400 nanometers. In another possible embodiment, the second face of the substrate comprises the anti-reflective coating. Similar to the first face, the anti-reflective coating on the second face helps minimize reflection of light in the visible range of light between 400 to 700 nanometers and the ultraviolet range of light between 300 to 400 nanometers.

In some embodiments, the lens treatment includes applying an anti-reflective coating in multiple coats. The coats comprise an adhesion composition, a low index composition (SiO₂), a high index composition (ZrO₂), and a superhydrophobic composition that are applied in subsequent layers of varying nanometer thicknesses. The treated lens exhibits minimal reflection properties in the visible range of the electromagnetic spectrum and almost no reflection in the UV-A range. This creates a lens surface that is difficult for mammals with dichromacy to see a reflection therefrom.

In another aspect, a method 700 for treating an optical lens to reduce the light wavelengths to make the optical lens less perceptible to mammals with dichromatic vision, comprises providing a lens, the lens comprising a first face and a second face, the surfaces being defined by UV absorbing properties; removing debris from the surfaces of the lens; etching the surfaces of the lens with an ultrasonic etching device.

If the lens is not hard-coated, dipping the lens into a primer solution; if the lens is not hard-coated, spinning the primer solution onto the lens; if the lens is not hard-coated, curing the lens in an oven. Nonetheless, the method further comprises a Step of plasma etching the surfaces of the lens to prepare the surfaces for adhesion of an anti-reflective coating.

In other embodiments, the method may include applying an anti-reflective coating in multiple coats comprising an adhesion composition, a low index composition, a high index composition, and a superhydrophobic composition, the multiple coats being coated on the surfaces of the lens as follows: applying an adhesion composition; applying 164.53 nm of a low index composition on the surfaces of the lens; applying 14.16 nm of a high index composition on the surfaces of the lens; applying 23.5 nm of the low index composition on the surfaces of the lens; applying 101 nm of the high index composition on the surfaces of the lens; applying 76.19 nm of the low index composition on the surfaces of the lens; applying a superhydrophobic composition on the surfaces of the lens.

Furthermore, if the anti-reflective coating is applied to one surface, flipping the lens and coating the opposite surface in the same manner. A final Step may also include integrating the lens into a viewing device, such as a rifle site or a binocular.

In another aspect, the lens comprises an optical lens.

In another aspect, the lens comprises the ability to filter UV as an inherent function of the lens substrate or by being UV treated. (E.g. Trivex® lens, a polycarbonate lens, High Index, a UV treated Cr-39 lens, or a glass lens.)

In another aspect, the vacuum coating is applied through an electron beam gun evaporation technique or a magnetron sputtering technique.

In another aspect, the low index composition comprises SiO₂.

In another aspect, the high index composition comprises ZrO₂.

One objective of the present invention is to provide a unique anti-reflection lens that prevents mammals, such as deer, from seeing reflections from the lens of a scope on a hunting rifle, binoculars and range finders, by treating the lens with an anti-reflective coating.

Another objective is to reduce the wavelengths of light reflected, such that a dichromatic mammal cannot see the reflections from the lens.

Yet another objective is to produce an optical lens or viewing surface that has the appearance of little to no reflection in the visible range of the electromagnetic spectrum.

Yet another objective is to enhance hunting for deer by reducing the odds that the deer will see the hunter, and the lens of the hunting rifle.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 shows a perspective side view of an anti-reflection lens, showing a substrate layered with compositions from an anti-reflective coating, in accordance with an embodiment of the present invention;

FIG. 2 shows a wavelength vs reflectance chart of a first embodiment of an anti-reflective coating reflecting at 2.1% in 700 nanometer range and 3.2% in the 350 nanometer range and 0° angle of incidence, in accordance with an embodiment of the present invention;

FIG. 3 shows a wavelength vs reflectance chart of a second embodiment of an anti-reflective coating reflecting at 2% in the 700 nanometer range and 2.9% in the 340 nanometer range at 15° angle of incidence, in accordance with an embodiment of the present invention;

FIG. 4 shows a wavelength vs reflectance chart of a third embodiment of an anti-reflective coating reflecting at 2.8% in the 700 nanometers range and 1.9% in the 325 nanometer range at 30° angle of incidence, in accordance with an embodiment of the present invention;

FIG. 5, fourth embodiment of the anti-reflective coating reflecting at 3.2% at 700 nanometers and 1.8% at 310 nanometer range at 45° angle of incidence, in accordance with an embodiment of the present invention;

FIG. 6, a fifth embodiment of the anti-reflective coating reflecting at 4.2% at the 700 nanometer range and 2.6% at 240 nanometer range at 60° angle of incidence, in accordance with an embodiment of the present invention; and

FIG. 7 shows a flowchart of an exemplary method for treating a lens to reduce reflections for a placental mammal with dichromatic vision, in accordance with an embodiment of the present invention.

Like reference numerals refer to like parts throughout the various views of the drawings.

### DETAILED DESCRIPTION OF THE INVENTION

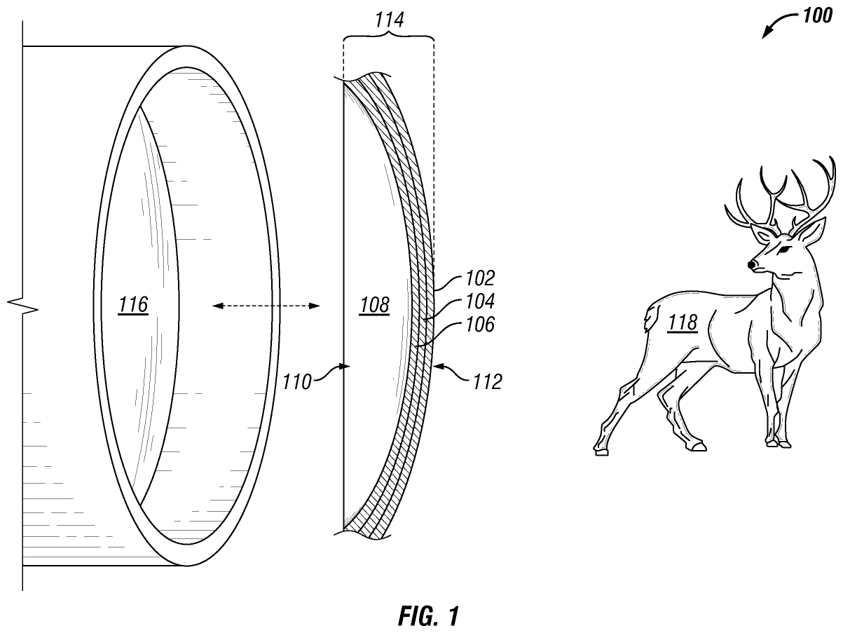

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An anti-reflection lens 100 and method 700 for treating a lens to reduce reflections for placental mammals with dichromatic vision is referenced in FIGS. 1-7. Specifically, the lens works to reduce light wavelengths that strike a lens substrate 102 operational inside a viewing device 116. The reduction of wavelengths, as described below, serves to make the substrate 102 less perceptible to mammals 118 with dichromatic vision, such as hoofed ruminant mammals, i.e., deer, elk, that are being hunted, for example.

The lens 102 and method 700 utilize a unique anti-reflective coating 114 that is sequentially layered on opposing faces 110, 112. It is the unique composition of the anti-reflective coating 114 that makes the faces 110, 112 of the substrates 102 less apparent or undetectable to the placental mammal 118. Specifically, reflections that appear on the substrate 102 at specific wavelengths of light are annulled through use of a unique anti-reflective coating 114 consisting of multiple compositions applied sequentially onto the faces of the substrate 102. In operation, the treated substrate is fitted in a viewing device 116, such as a rifle site or binoculars, for operational use thereof.

FIG. 1 shows a perspective side view of an exemplary substrate 102 utilized with the anti-reflection lens 100. In some embodiments, the substrate 102 is selected for treatment. Initially before treatment, the substrate 102 must absorb 97%+UV in all ranges. Further, the selected substrate 102 must be hand cleaned to remove all debris and contaminants that may create defects in the final optical lens product. The substrate 102 has a first face comprising an anti-reflective coating 114 that is configured to be coated onto the faces in multiple stages, through vacuum process.

The substrate 102 is shown layered with compositions from an anti-reflective coating 114. As illustrated, the lens 100 comprises a substrate 102 having a first face 110 and a second face 112. The faces 110, 112 are defined by UV absorbing properties. The first face 110 of the substrate comprises an anti-reflective coating 114. In one possible embodiment, the anti-reflective coating 114 helps minimize reflection of light in the visible range of light between 400 to 700 nanometers and the ultra violet range of light between 300 to 400 nanometers.

In another possible embodiment, the second face 112 of the substrate 102 comprises the anti-reflective coating 114. Similar to the first face 110, the anti-reflective coating 114 on the second face 112 helps minimize reflection of light in the visible range of light between 400 to 700 nanometers and the ultraviolet range of light between 300 to 400 nanometers.

The substrate 102 is treated by applying an anti-reflective coating 114 in multiple coats. The treatment applied to the substrate 102 is designed to minimize reflection of light in the visible range of light between 400-700 nanometers, or the UV range between 300-400 nanometers. The faces of the substrate 102 have UV absorbing properties. This inherent quality of substrate works in conjunction with anti0reflective coating 114 to create the unique anti-reflection properties.

In some embodiments, the layers of coating may include an adhesion composition 102, a low index composition 104 (SiO₂), a high index composition 106 (ZrO₂), and a superhydrophobic composition 108 that are applied in subsequent layers of varying nanometer thicknesses. After treatment, the substrate 102 has the appearance of little to no reflection in the visible range of the electromagnetic spectrum, and little to no reflection in the UV-A range. This creates an imperceptible lens to the placental mammal; thereby making it difficult for the placental mammal to discover the lens.

In some embodiments, if the substrate 102 is not hard-coated, the substrate 102 is carried through a hard-coating process, as described below. If the substrate 102 is hard-coated, the hard-coating steps described below are not utilized. Further, if the substrate 102 is hard-coated, but the manufacturer wishes to apply a better hard-coat to the substrate 102, the substrate 102 is passed through a strip and dip process.

Similar to the first face 110 of the substrate 102, the second face 112 of the substrate 102 includes an anti-reflective coating 114 that is configured to minimize reflection of light in the visible range of light between 400-700 nanometers, or the UV range between 300-400 nanometers. In this manner, the internal absorption of the substrate 102 absorbs 97%+of the UV in all ranges. Thus, the substrate 102 creates little to no reflection in the visible range of the electromagnetic spectrum and little to no reflection in the UV-A range. This lack of reflective properties from the point of view of a mammal with dichromatic eyesight is also at normal angles of incidence as well as off axis angles of incidence up to 60°.

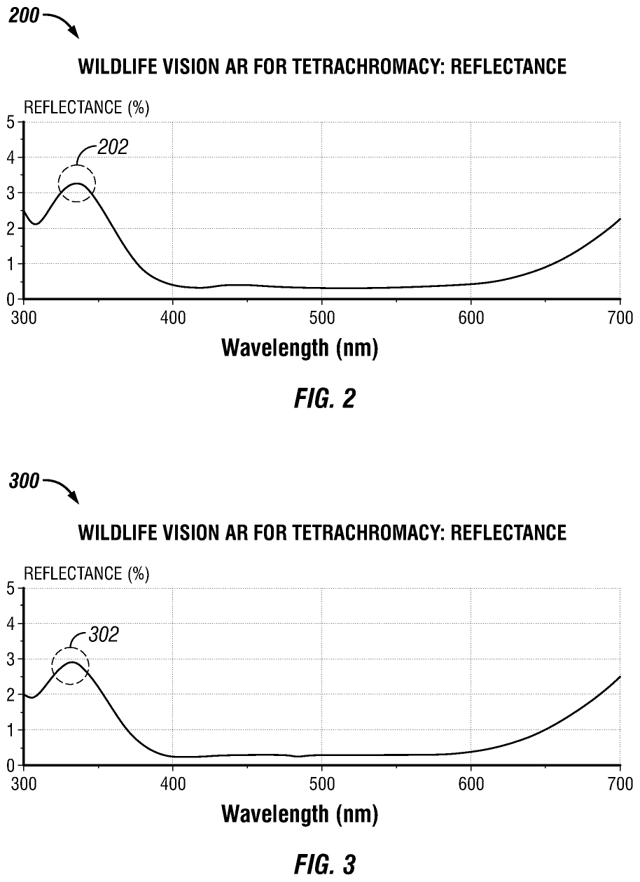

In some embodiments, the anti-reflective composition can be adjusted to vary the amount of reflectiveness from the coated substrate 102. For example, FIG. 2 references a first embodiment of an anti-reflective coating 200 that exhibits an optimal reflectance percentage 202 of 2.1% in 700 nanometer range and 3.2% in the 350 nanometer range and 0° angle of incidence. This is effective for substantially eliminating glare for the lens.

Other variations of reflection on the lens are also possible. For example, FIG. 3 references a second embodiment of anti-reflective coating 300 exhibits a reflectance percentage 302 of 2% in the 700 nanometer range and 2.9% in the 340 nanometer range at 15° angle of incidence. This configuration is also efficacious for reducing glare/reflections from the faces 110, 112 of the substrate; and thereby substantially eliminating glare for the substrate 102.

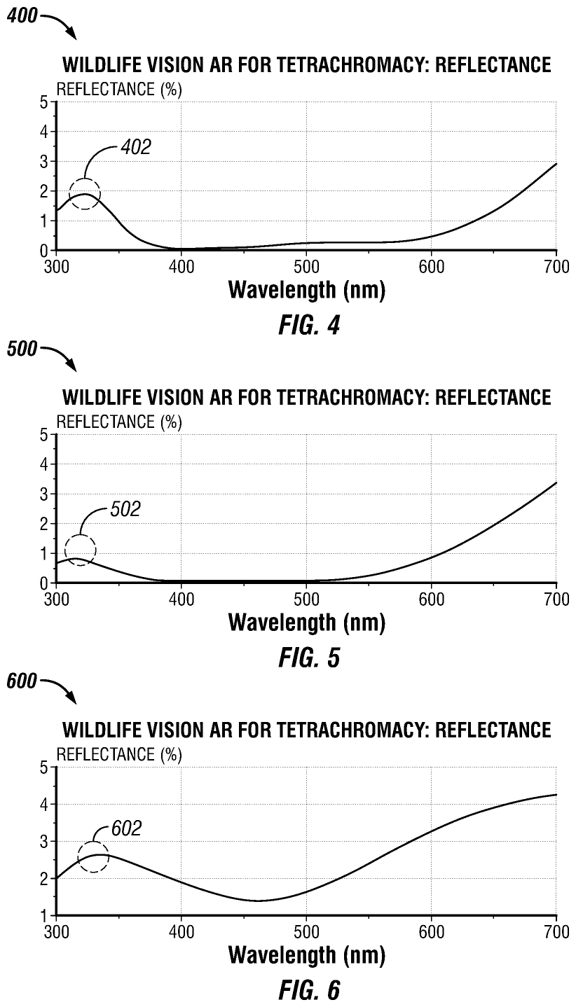

In yet another variation shown in FIG. 4, a third embodiment of anti-reflective coating 400 exhibits a reflectance percentage 402 of 2.8% in the 700 nanometers range and 1.9% in the 325 nanometer range at 30° angle of incidence. As shown in FIG. 5, fourth embodiment of the anti-reflective coating 500 exhibits a reflectance percentage 502 of 3.2% at 700 nanometers and 1.8% at 310 nanometer range at 45° angle of incidence.

A final variation of the non-reflective coating is shown in FIG. 6. Here, a fifth embodiment of the anti-reflective coating 600 exhibits a reflectance percentage 602 of 4.2% at the 700 nanometers range and 2.6% at 240 nanometer range at 60° angle of incidence.

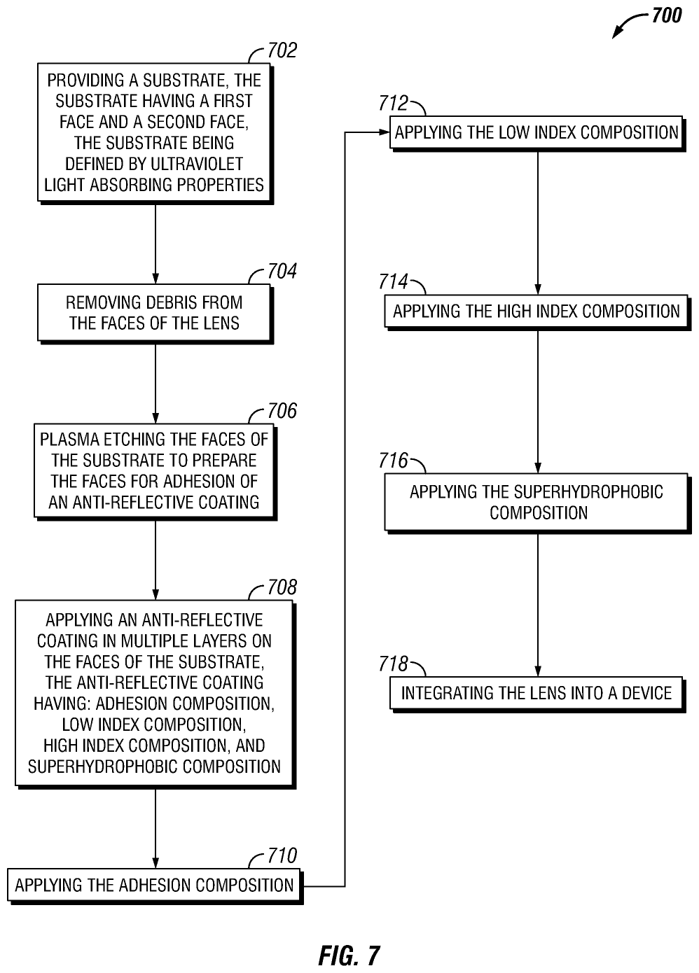

Turning now to the actual method, FIG. 7 illustrates a flowchart diagram of an exemplary method 700 for treating a lens to reduce reflections for placental mammals with dichromatic vision. In one possible embodiment, the method 700 has an initial Step 702 of providing a substrate, the substrate having a first face and a second face, the substrate being defined by ultraviolet light absorbing properties.

In some embodiments, the method 700 may further comprise a Step 704 of removing debris from the faces of the lens. This debris removal, or cleaning, may include ultrasonic cleaning methods known in the art. A Step 706 comprises plasma etching the surfaces of the substrate 102 to prepare the surfaces for adhesion of an anti-reflective coating 114. The etching helps further clean the first and second faces of the lens.

In some embodiments of the present invention, whether the substrate is hard-coated is determinative of additional steps. For example, if the substrate 102, or optical element/lens, is not hard-coated, the substrate 102 is carried through the hard-coating process, as described below. But if the substrate is hard-coated, the hard-coating steps described below are not performed. Further, if the substrate is hard-coated, but the manufacturer wishes to apply a better hard-coat to the substrate 102, the substrate passes through a strip and dip process. Thus, if the substrate 102 is not hard-coated, dipping the lens into a primer solution.

After the ultrasonic cleaning, the substrate 102 is dipped into a primer solution, to prep the substrate 102 for dip hard-coating. But if the substrate 102 is not hard-coated, spinning the primer solution onto the substrate 102. Finally, if the substrate 102 is not hard-coated, curing the lens in an oven. Following the hard-coating of the lenses, the hard-coat will need to be cured. The lens is transferred to a curing oven for curing, as known in the art.

A Step 708 includes applying an anti-reflective coating 114 in multiple layers on at least one face of the substrate, the anti-reflective coating 114 comprising an adhesion composition, a low index composition, a high index composition, and a superhydrophobic composition. In some embodiments, the anti-reflective coating 114 can be applied in a vacuum coating system, either through an electron beam gun evaporation technique or via a magnetron sputtering technique.

In some embodiments, the anti-reflective coating 114 that coats the faces of the substrate 102 include: an adhesion composition; a low index composition, a high index composition, and a superhydrophobic composition. In one embodiment, the low index composition is SiO₂. In other embodiments, a similar low index composition may also be used. In another embodiment, the high index composition is ZrO₂.

In other embodiments, a similar high index composition may also be used. A step 710 includes applying the adhesive composition. A Step 712 includes applying the low index composition. A Step 714 includes applying the high index composition. A Step 716 includes applying the superhydrophobic composition.

In one non-limiting embodiment, the layering of coats of the face(s) is as follows: 1) applying the adhesion composition; 2) applying 164.53 nm of the low index composition on the faces of the substrate; 3) applying 14.16 nm of the high index composition on the faces of the substrate 102; 4) applying 23.5 nm of the low index composition on the faces of the substrate 102; 5) applying 101 nm of the high index composition on the faces of the substrate 102; 6) applying 76.19 nm of the low index composition on the faces of the substrate 102; and 7) applying a superhydrophobic composition on the faces of the substrate 102. The adhesion composition may include a glue, silicone, or other adhesive known in the art of lenses. The low index composition may include SiO₂. The high index composition may include ZrO₂.

Different variations of nanometer thickness, the low index composition and the high index composition may also be used. And as described above, the application occurs in a vacuum coating system, either through electron beam gun evaporation techniques or via magnetron sputtering techniques. It is significant to note that if the anti-reflective coating is applied to one face, flipping the substrate 102 and coating the opposite face in the same manner.

A final Step 618 comprises integrating the substrate 102 into a viewing device 116; whereby the anti-reflection properties of the substrate 102 become inherent to the viewing device 116. The present invention can be produced on a wide range of viewing devices with unique optical elements, including gun sight lenses, ophthalmic lenses, camera lenses, and binocular/scope lenses. Because one objective for treating the substrate 102 in this manner is to minimize reflections for placental mammals, the substrate 102 can be especially effective when operable in a gunsight or scope lens used with hunting rifles.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An anti-reflection lens, the lens comprising:
a substrate having a first face and a second face, the faces being defined by UV absorbing properties,
the first face of the substrate comprising an anti-reflective coating, whereby the anti-reflective coating helps minimize reflection of light in the visible range of light between 400 to 700 nanometers and the ultra violet range of light between 300 to 400 nanometers,
the second face of the substrate comprising the anti-reflective coating, whereby the anti-reflective coating helps minimize reflection of light in the visible range of light between 400 to 700 nanometers and the ultraviolet range of light between 300 to 400 nanometers.

2. The lens of claim 1, wherein the substrate is defined by an internal absorption configured to absorb at least 97 percent of ultraviolet light.

3. The lens of claim 1, wherein the anti-reflective coating comprises an adhesion composition, a low index composition, a high index composition, and a superhydrophobic composition.

4. The lens of claim 3, wherein at least one of the faces of the substrate is coated with about 164.53 nm of the low index composition.

5. The lens of claim 4, wherein at least one of the faces of the substrate is coated with about 14.16 nm of the high index composition.

6. The lens of claim 5, wherein at least one of the faces of the substrate is coated with about 23.5 nm of the low index composition.

7. The lens of claim 6, wherein at least one of the faces of the substrate is coated with about 101 nm of the high index composition.

8. The lens of claim 7, wherein at least one of the faces of the substrate is coated with about 76.19 nm of the low index composition.

9. The lens of claim 3, wherein the low index composition comprises SiO₂

10. The lens of claim 3, wherein the high index composition comprises ZrO₂.

11. A method for treating a lens to reduce reflections for placental mammals with dichromatic vision, the method comprising:
providing a substrate, the substrate having a first face and a second face, the substrate being defined by ultraviolet light absorbing properties;
removing debris from the faces of the substrate;
plasma etching the faces of the substrate;
applying an anti-reflective coating in multiple layers on at least one face of the substrate, the anti-reflective coating comprising an adhesion composition, a low index composition, a high index composition, and a superhydrophobic composition, the compositions being sequentially applied in layers as follows:
applying the adhesion composition;
applying the low index composition;
applying the high index composition;
applying the superhydrophobic composition; and
integrating the substrate into a viewing device.

12. The method of claim 11, further comprising a step of etching the faces of the substrate with an etching device.

13. The method of claim 11, wherein the step of applying the low index composition, further comprises applying 164.53 nanometers of the low index composition.

14. The method of claim 13, wherein the step of applying the high index composition, further comprises applying 14.16 nanometers of the high index composition.

15. The method of claim 14, wherein the step of applying the low index composition, further comprises applying 23.5 nanometers of the low index composition.

16. The method of claim 15, wherein the step of applying the high index composition, further comprises applying 101 nanometers of the high index composition.

17. The method of claim 11, further comprising a step of dipping the substrate into a primer solution, if the substrate is not hard-coated.

18. The method of claim 11, further comprising a step of spinning the primer solution onto the substrate, if the substrate is not hard-coated.

19. The method of claim 11, further comprising a step of curing the substrate in an oven, if the substrate is not hard-coated.

20. A method for treating a lens to reduce reflections for placental mammals with dichromatic vision, the method comprising:
providing a substrate, the substrate having a first face and a second face, the substrate being defined by ultraviolet light absorbing properties;
removing debris from the faces of the substrate;
etching the faces of the substrate with an etching device;
if the substrate is not hard-coated, dipping the substrate into a primer solution;
if the substrate is not hard-coated, spinning the primer solution onto the substrate;
if the substrate is not hard-coated, curing the substrate in an oven;
plasma etching the faces of the substrate to prepare the faces for adhesion of an anti-reflective coating;
applying the anti-reflective coating in multiple layers on at least one face of the substrate, the anti-reflective coating comprising an adhesion composition, a low index composition, a high index composition, and a superhydrophobic composition, the compositions being sequentially applied in layers as follows:
applying the adhesion composition;
applying 164.53 nanometers of the low index composition;
applying 14.16 nanometers of the high index composition;
applying 23.5 nanometers of the low index composition;
applying 101 nanometers of the high index composition;
applying the superhydrophobic composition; and
integrating the substrate into a viewing device.
